(19) United States
(12) Patent Application Publication
(10) Pub. No.: US 2017/0166741 A1
(43) Pub. Date: Jun. 15, 2017

(54) FINELY DIVIDED, STARCH-CONTAINING POLYMER DISPERSIONS, PROCESSES FOR THEIR PREPARATION AND USE AS SIZES IN PAPERMAKING

(71) Applicant: BASF SE, Ludwigshafen (DE)

(72) Inventors: Titus David LEMAN, Shanghai (CN); Christian JEHN-RENDU, Shanghai (CN); Holger KERN, Kirchardt (DE); Syarief B CAHYANA, Singapore (SG)

(73) Assignee: BASF SE, Ludwigshafen (DE)

(21) Appl. No.: 15/323,637

(22) PCT Filed: Jul. 2, 2015
(86) PCT No.: PCT/IB2015/054998

§ 371 Date: Jan. 3, 2017

(30) Foreign Application Priority Data
Jul. 4, 2014 (CN) PCT/CN2014/081657

(51) Int. Cl. C08L 33/20; D21H 17/37; D21H 17/29; C09D 133/20; D21H 21/16

(52) U.S. Cl. CPC C08L 33/20; C09D 133/20; D21H 21/16; D21H 17/29; D21H 17/375; C08L 2201/54

(57) ABSTRACT

The invention relates to a finely divided, starch-containing aqueous polymer dispersion which is obtainable by free radical emulsion polymerization of ethylenically unsaturated monomers in the presence of at least one redox initiator and starch, wherein the ethylenically unsaturated monomers comprise (a) from 30 to 65% by weight of acrylonitrile and/or methacrylonitrile, (b) from 35 to 60% by weight of at least one C₁-C₁₂-alkyl acrylate and/or at least one C₁-C₁₂-alkyl methacrylate, (c) from 0 to 35% by weight of at least one other ethylenically unsaturated copolymerisable monomer, in which the sum of (a), (b) and (c) totals 100%, and in which the aqueous polymer dispersion comprises, (d) from 10 to 55% by weight of an ionic tapioca starch, in which the weight of (d) is based on the total solids of components (a), (b), (c) and (d) of the aqueous polymer dispersion. The invention also relates to a process for the manufacture of the finely divided, starch containing aqueous polymer dispersions and also to the use of said finely divided starch containing aqueous polymer dispersions as a size for paper, board and cardboard.

The invention relates to finely divided, starch containing polymer dispersions which are obtainable by free radical emulsion polymerization of ethylenically unsaturated monomers in the presence of at least one redox initiator and starch. The invention also defies processes for the preparation of the dispersions and the use of said dispersions as sizes and coating materials for paper.

EP 276770 B1 and EP 257412 B2 disclose sizes based on finely divided, aqueous dispersions which are obtainable by copolymerisation of ethylenically unsaturated monomers, such as acrylonitrile and (meth) acrylates and optionally up to 10% by weight of other monomers, such as styrene, by emulsion polymerisation in the presence of initiators comprising peroxide groups, in particular of redox initiators, and degraded starch. The use of chain transfer agent, such as terpenes

EP 307812 A describes, as sizes, inter-alia also finely divided, aqueous, cationic polymer dispersions which are obtainable by emulsion copolymerisation of
(i) acrylonitrile, methacrylonitrile, methyl methacrylate and/or styrene,
(ii) at least one acrylate or methacrylate of in each case monohydric, saturated C₃-C₈-alcohols, vinyl acetate, vinyl propionate and/or 1, 3-butadiene and, if appropriate,
(iii) other ethylenically unsaturated monomers, in of an aqueous solution of a degraded cationic starch and in the presence of a redox initiator.

EP 536597 A discloses aqueous polymer dispersions which are obtainable by free radical emulsion copolymerisation of unsaturated monomers in the presence of a starch degradation product. The starch degradation product forms as a result of hydrolysis in the aqueous phase and, at room temperature, has complete solubility in water at a weight average molecular weight M_{w} of from 2500 to 25,000. Preferably used monomer mixtures are mixtures of styrene and (meth) acrylates of monohydric, saturated C₁-C₁₂-alcohols in combination with up to 10% by weight of acrylic acid and/or methacrylic acid. The dispersions are used as binder, adhesive or size for fibres or for the production of coatings.

EP 1056783 B likewise discloses aqueous, finely divided polymer dispersions which are used for the surface sizing of paper, board and cardboard. The dispersions are obtainable by free radical emulsion polymerisation of ethylenically unsaturated monomers in the presence of degraded starch having a number average molecular weight Mₙ of from 500 to 10,000. The monomer mixtures consist of (i) at least one optionally substituted styrene, (ii) at least one C₁-C₄-alkyl (meth) acrylate and (iii) if appropriate up to 10% by weight by weight of other ethylenically unsaturated monomers. The polymerisation is effected in the presence of a graft-linking, water soluble redox system.

WO 00/23479 A likewise discloses sizes which are obtainable by free radical emulsion copolymerisation of a monomer mixture (A) comprising, for example, (i) at least one optionally substituted styrene, (ii) optionally at least one C₄-C₁₂-alkyl (meth) acrylate and (iii) at least one monomer from the group consisting of methyl acrylate ethyl acrylate and propyl acrylate in the presence of (B) starch having an average molecular weight of 1000 or more, the weight average ratio of (A):(B) from 0.6:1 to 1.7:1; the size is free of emulsifiers or surface active agents having a molecular weight of less than 1000 and comprises virtually no monomers which have acid groups and are incorporated in the form of polymerised units. Cationic starch, in particular oxidised cationic waxy maize starch, is preferred as component (B) of the size, and the component (A) preferably consists of a mixture of styrene, n-butyl acrylate and methyl acrylate.

EP 1165642 B discloses a further polymer dispersion and a process for its preparation, a monomer mixture which comprises at least one vinyl monomer being polymerised in an aqueous solution of starch which has a degree of substitution (DS), based on the cationic or anionic substituents, of from 0.01 to 1 and, in cationised and/or anionised form, has a limiting viscosity of >1.0 dl/g. The starch used in the polymerisation is either not degraded or only slightly oxidised but on no account enzymatically degraded. The resulting polymer has a film formation temperature of −50 to +200° C. It is composed, for example, of acrylates and styrene and, if appropriate, acrylonitrile. The polymer dispersions thus preparable are used as sizes for paper stock

According to the process disclosed in WO 02/14393, sizes and coating materials for paper are prepared by free radical emulsion polymerisation of a monomer mixture comprising (i) at least one (meth) acrylate of monohydric, saturated C₃-C₈-alcohols and (ii) one or more further ethylenically unsaturated monomers in the presence of starch and/or of a starch derivative, monomers and initiator being fed continuously to an aqueous starch solution, and be initiator being metered in two portions under specially defined conditions.

Also known are starch-based polymers which can be prepared by polymerisation of (i) from 35 to 65% by weight of an ethylenically unsaturated monomer which is free of carboxyl groups, (ii) from 35 to 65% by weight of an ethylenically unsaturated mono- or dicarboxylic acid or the salts thereof and (iii) from 0 to 15% by weight of another ethylenically unsaturated monomer in an aqueous medium in the presence of starch, cf. WO 2004/078807. The starch used may be natural starch, dextrin and starch derivatives. The polymers formed are water-soluble. They are used as sizes for paper, board and cardboard.

US 2012/0180970 describes starch containing polymer dispersions which are obtainable by free radical emulsion copolymerisation of ethylenically unsaturated monomers in the presence of at least one redox initiator and starch. The ethylenically unsaturated monomers comprise (i) optionally substituted styrene, methyl methacrylate, acrylonitrile and/or methacrylonitrile, (ii) at least one C₁-C₁₂-alkyl acrylate and/or one C₂-C₁₂-alkyl methacrylate and optionally other ethylenically unsaturated copolymerisable monomer. The starch is a degradable cationised starch which has a molar mass M_{w}, of from 1000 to 65,000.

It is an object of the invention to provide further starch containing polymer dispersions which are suitable for sizing paper, board. A further object is for such starch containing polymer dispersions to have improved sizing performance especially for recycled paper and/or liner paper applications.

According to the present invention we provide a finely divided, starch-containing aqueous polymer dispersion which is obtainable by free radical emulsion polymerization of ethylenically unsaturated monomers in the presence of at least one redox initiator and starch, wherein the ethylenically unsaturated monomers comprise
(a) from 30 to 65% by weight of acrylonitrile and/or methacrylonitrile,
(b) from 35 to 60% by weight of at least one C₁-C₁₂-alkyl acrylate and/or at least one C₁-C₁₂-alkyl methacrylate,
(c) from 0 to 35% by weight of at least one other ethylenically unsaturated copolymerisable monomer,
   in which the sum of (a), (b) and (c) totals 100%,
   and in which the aqueous polymer dispersion comprises,
(d) from 10 to 55%, such as 15 to 40%, by weight of an ionic tapioca starch, in which the weight of (d) is based on the total solids of components (a), (b), (c) and (d) of the aqueous polymer dispersion.

The invention also relates to a process for the preparation of the finely divided starch containing polymer dispersions.

Ethylenically unsaturated monomers of group (a) are, acrylonitrile or methacrylonitrile.

Suitable monomers of group (b) are, for example, all esters of acrylic acid and of methacrylic acid which are derived from monohydric C₂- to C₁₂-alcohols, such as ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, sec-butyl acrylate, sec-butyl methacrylate, n-pentyl acrylate, n-pentyl methacrylate, neopentyl acrylate, neopentyl methacrylate, cyclohexyl acrylate, cyclohexyl methacrylate, 2-hexyl acrylate, 2-hexyl methacrylate, 2-ethylhexyl acrylate, 2-ethylhexyl methacrylate, n-octyl acrylate, n-octyl methacrylate, isooctyl acrylate, isooctyl methacrylate, decyl acrylate and decyl methacrylate, dodecyl acrylate and dodecyl methacrylate. Another suitable acrylate is methyl acrylate. Preferably used monomers of this group are n-butyl acrylate, sec-butyl acrylate, isobutyl acrylate and tert-butyl acrylate.

Examples of monomers of group (c) are stearyl acrylate, stearyl methacrylate, palmityl acrylate, behenyl acrylate, behenyl methacrylate, vinyl acetate, vinyl propionate, hydroxyethyl acrylate, hydroxyethyl methacrylate, N-vinylformamide, acrylamide, methacrylamide, N-vinylpyrrolidone, N-vinylimidazole, N-vinylcaprolactam, acrylic acid, methacrylic acid, acrylamidomethylpropane-sulfonic acid, vinylsulfonic acid, styrenesulfonic acid and salts of the monomers comprising acid groups. The acidic monomers may be used in partly or completely neutralized form. Neutralizing agents used are, for example, sodium hydroxide solution, potassium hydroxide solution, sodium carbonate, sodium bicarbonate, calcium hydroxide and ammonia.

Further examples of monomers (c) are dialkylaminoalkyl (meth)acrylates and dialkylaminoalkyl(meth)acrylamides, such as dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, dimethylaminoethylacrylamide, dimethylaminoethylmethacrylamide, dimethylaminopropylacrylamide and dimethylaminopropylmethacrylamide. The basic monomers can be used in the form of the free bases, as salts with organic acids or mineral acids or in quaternized form in the polymerization. The monomers of group (d) are present in an amount of, for example, from 0 to 35% by weight in the ethylenically unsaturated monomer components (a), (b), and (c). If they are used for modifying the polymers, the preferably used amounts are from 0.5 to 15% by weight, suitably 0.5 to 8%, based on the reaction mixture comprising the components (a), (b), and (c).

The polymerization of the monomers is effected in the presence of an ionic tapioca starch. Suitably the ionic tapioca starch has a molar mass M_{w} of from 1000 to 65 000 g/mol. If the molecular weight M_{w} of the ionic tapioca starch used is not already in the range from 1000 to 65 000 g/mol, the molecular weight of said starch can be degraded, for example enzymatically and/or oxidatively, if appropriate before the beginning of polymerization or in a separate step. The molar mass M_{w} of the degraded ionic tapioca starch is preferably in the range from 2500 to 35 000 g/mol. The average molecular weight M_{w} of the degraded starches can readily be determined by methods known to the person skilled in the art, for example by means of gel permeation chromatography using a multi-angle scattered light detector.

Tapioca starch is obtained from the root of the cassava plant (also known as yuca, manioc or mandioca). It composed of 17% of amylose (linear part) and 83% amylopectine (branched part) and its granular shape has rounded grains truncated with size diameter of 5-25 microns. It produces gel of clarity and flexibility and because it has no cereal flavor, it can be used directly for thickening foodstuff. Cassava plant is a starchy vegetable that is widely grown in most tropical countries: Asia, Africa, Latin America and Caribbean

Desirably the tapioca starch is anionic or cationic. Suitably anionic tapioca starch can be obtained by anionically modifying tapioca starch and cationic tapioca starch can be obtained by cationising modifying tapioca starch.

Cationised tapioca starch may be prepared, for example, by reacting tapioca starch with at least one quaternising agent, such as 2,3-epoxypropyltrimethylammonium chloride. A suitable quaternising agent may for instance be Quat 188 (aqueous solution of 3-chloro-2-hydroxy propyl trimethyl ammonium chloride), available from the Dow Chemical Company. The cationised tapioca starch comprises quaternary ammonium groups. The proportion of the cationic groups in the cationised starch is stated with the aid of the degree of substitution (DS). It is, for example, from 0.005 to 1.0, preferably from 0.01 to 0.5 and more preferably 0.01 to 0.07 mol/mol.

Typically the DS of each cationic starch can be based on nitrogen increase of the exhaustively washed product and can be calculated from the formula: DS=162(% N)/[1,400-117(% N)]. Nitrogen can be determined by the Kjeldahl method and sulfur by the Schoniger combustion method. Conventionally known methods for preparing cationic starches in general may also be applied to preparing cationic tapioca starches. A typical reference preparing cationic starches includes Starch 33 (1981) pages 310-312, entitled “Preparation of cationic starch ether.”

In the case of anionic tapioca starches, these are obtained, for example, by oxidative reaction of the native tapioca starch with a suitable oxidizing agent, such as sodium hypochlorite or peroxiodate. Then the oxidized anionic starch is acetylated using vinyl acetate monomer or Hydroxypropylated or acetic anhydride to improve viscosity starch solution stability. The degree of anionic character is dependent upon the type of anionic groups. Anionic groups may be carboxyl, sulphonate, sulphate or phosphate. It may be desirable to measure the amount of an anionicty of the anionic starch by measuring the charge density.

The cationic or anionic tapioca starch can be further modified, for example hydrophobically modified, by etherification, esterification or crosslinking. The degradation of the cationic or anionic tapioca starch can be effected before or during the polymerization of the monomers. The starch degradation is preferably carried out before the polymerization. It can be carried out oxidatively, thermally, acidolytically or enzymatically. The starch degradation is preferably effected enzymatically and/or oxidatively directly before the beginning of the emulsion polymerization in the polymerization apparatus or in a separate step. It is possible to use a single degraded anionic or cationic starch or mixtures of two or more degraded cationic or anionic starches in the polymerization.

The polymerisation of the monomers may be carried out in the absence of chain transfer agent. However, it is preferred that the polymerisation is conducted in the presence of at least one chain transfer agent. Suitable chain transfer agents are, for example, mercaptans, such as ethyl mercaptan, n-butyl mercaptan, tert-butyl mercaptan, n-dodecyl mercaptan or tetradodecyl mercaptan, thioglycolic acid, 2-mercaptoethanol and 2-ethylhexyl thioglycolate, carbon tetrabromide, or isopropanol. Nonetheless, preferred chain transfer agents are from the class consisting of the terpenes, more preferably from the class consisting of the monocyclic terpenes and particularly preferably from a group consisting of the menthadienes. Among said chain transfer agents of the group consisting of menthadienes, terpinolene is very particularly preferred. If polymerisation chain transfer agents, for instance terpene containing chain transfer agent, are used, the amounts of chain transfer agent are, for example, at least 0.01% by weight based on the weight of the ethylenically unsaturated monomers. Suitably 0.1 to 10% by weight of the chain transfer agent is used, preferably from 0.3 to 5% by weight.

In order to initiate the polymerization, according to the invention a redox initiator is used. Redox initiators are preferably graft-linking, water-soluble redox systems, for example comprising hydrogen peroxide and a heavy metal salt or comprising hydrogen peroxide and sulfur dioxide or comprising hydrogen peroxide and sodium metabisulfite. Further suitable redox systems are combinations of tert-butyl hydroperoxide and/or sulfur dioxide, sodium or potassium persulfate/sodium bisulfite, ammonium persulfate/sodium bisulfite or ammonium persulfate/iron(II) sulfate. Preferably, hydrogen peroxide is used in combination with a heavy metal salt, such as iron(II) sulfate. Frequently, the redox system additionally comprises a further reducing agent, such as ascorbic acid, sodium formaldehyde sulfoxylate, sodium disulfite and/or sodium dithionite. Since the polymerization of the monomers is effected in the presence of starch and since starch likewise acts as a reducing agent, in general the concomitant use of further reducing agents is dispensed with. The redox initiators are used, for example, in an amount of from 0.05 to 5% by weight, preferably from 0.1 to 4% by weight, based on the monomers.

The emulsion polymerization of the monomers (a) to (c) is effected in an aqueous medium in the presence of a cationized starch (d). The polymerization can be carried out both by the feed process and by a batch process. Preferably, an aqueous solution of a degraded cationic starch and of a heavy metal salt is initially taken and the monomers are added either separately or as a mixture and, separately therefrom, the oxidizing part of the redox initiator, preferably hydrogen peroxide, is added, continuously or discontinuously or batchwise. A step or gradient procedure which is disclosed in WO-A-02/14393 can also be used for the preparation of the starch-containing polymer dispersions. There, the addition can be effected uniformly or nonuniformly over the metering period, i.e. with changing metering rate.

The polymerization is usually carried out in the absence of oxygen, preferably in an inert gas atmosphere, for example under nitrogen. During the polymerization, thorough mixing of the components should be ensured. Thus, the reaction mixture is preferably stirred during the entire duration of the polymerization and of any subsequent post-polymerization.

The polymerization is usually carried out at temperatures of from 30 to 110° C., preferably from 50 to 100° C. The use of a pressure reactor or carrying out a continuous polymerization in a stirred kettle cascade or flow tube is also possible.

In order to increase the dispersing effect, conventional ionic, nonionic or amphoteric emulsifiers can be added to the polymerization batch. Conventional emulsifiers are used only if appropriate. The amounts used are from 0 to 3% by weight and are preferably in the range from 0.02 to 2% by weight, based on the sum of the monomers (a) to (c) used. However, the emulsion polymerization is particularly preferably carried out in the absence of an emulsifier. Conventional emulsifiers are described in detail in the literature, cf. for example M. Ash, I. Ash, Handbook of Industrial Surfactants, Third Edition, Synapse Information Resources Inc. Examples of conventional emulsifiers are the reaction products of long-chain monohydric alcohols (C₁₀- to C₂₂-alkanols) with from 4 to 50 mol of ethylene oxide and/or propylene oxide per mole of alcohol or ethoxylated phenols or alkoxylated alcohols esterified with sulfuric acid which are generally used in a form neutralized with alkali. Further conventional emulsifiers are, for example, sodium alkanesulfonates, sodium alkylsulfates, sodium dodecylbenzenesulfonate, sulfosuccinic esters, quaternary alkylammonium salts, alkylbenzylammonium salts, such as dimethyl-C₁₂- to C₁₈-alkylbenzylammonium chlorides, primary, secondary and tertiary fatty amine salts, quaternary amidoamine compounds, alkylpyridiniumsalts, alkylimidazolinium salts and alkyloxazolinium salts.

During the emulsion polymerization, either the monomers can be metered directly into the initially taken mixture or they can be added in the form of an aqueous emulsion or miniemulsion to the polymerization batch. For this purpose, the monomers are emulsified in water using the abovementioned conventional emulsifiers.

The polymerization can, if appropriate, also be carried out in the presence of conventional regulators. In principle, all known regulators which reduce the molecular weight of the polymers forming can be used, but preferably used regulators are organic compounds which comprise sulfur in bound form, for example mercaptans, di- and polysulfides, esters and sulfides of thio- and dithiocarboxylic acids and enol sulfides. Halogen compounds, aldehydes, ketones, formic acid, enol ethers, enamines, hydroxylamine, halogenated hydrocarbons, alcohols, ethylbenzene and xylene are also suitable as regulators.

Examples of regulators based on organic compounds which comprise sulfur in bound form are mercaptoethanol, mercaptopropanol, mercaptobutanol, thioglycolic acid, thioacetic acid, thiopropionic acid, thioethanolamine, sodium dimethyldithiocarbamate, cysteine, ethyl thioglycolate, trimethylolpropane trithioglycolate, pentaerythrityl tetra(mercaptopropionate), pentaerythrityl tetrathioglycolate, trimethylolpropane tri(mercaptoacetate), butyl methylenebisthioglycolate, thioglycerol, glyceryl monothioglycolate, n-octadecyl mercaptan, n-dodecyl mercaptan, tertdodecyl mercaptan, butyl mercaptan, thiophenol, mercaptotrimethoxysilane and acetylcysteine.

Other suitable regulators are halogen compounds, such as trichloromethane, tetrachloromethane and bromotrichloromethane, aldehydes, such as acetaldehyde, propionaldehyde, crotonaldehyde and butyraldehyde, alcohols, such as n-propanol and isopropanol and buten-3-ol and allyl alcohol. Further suitable regulators are vitamin A acetate, vitamin A palmitate, geranial, neral, geraniol, geranyl acetate, limonene, linalyl acetate, terpinolene, γ-terpinene, α-terpinene, R(−)-α-phellandrene, terpineol, resorcinol, hydroquinone, pyrocatechol, phloroglucine and diphenylethylene. Further examples of regulators based on terpinolene and unsaturated alicyclic hydrocarbons are to be found, for example, in Winnacker-Küchler, Chemische Technologie, Volume 6, pages 374 to 381, Carl Hanser Verlag, Munich, Vienna, 1982.

The amount of regulator is, for example, from 0 to 5, preferably from 0.1 to 2, % by weight, based on the monomers (a)-(c).

The polymerization is carried out at a pH of from 2 to 9, preferably in the weakly acidic range at a pH of from 3 to 5.5. The pH can be adjusted to the desired value before or during the polymerization using conventional acids, such as hydrochloric acid, sulfuric acid or acetic acid, or using bases, such as sodium hydroxide solution, potassium hydroxide solution, ammonia, ammonium carbonate, etc. The dispersion is preferably adjusted to a pH of from 5 to 7 with sodium hydroxide solution, potassium hydroxide solution or ammonia after the end of the polymerization.

In order to remove the remaining monomers from the starch-containing polymer dispersion as substantially as possible, a postpolymerization is expediently carried out. For this purpose, an initiator from the group consisting of hydrogen peroxide, peroxides, hydroperoxides and/or azo initiators is added to the polymer dispersion after the end of the main polymerization. The combination of the initiators with suitable reducing agents, such as, for example, ascorbic acid or sodium bisulfite, is also possible. Oil-soluble initiators which are sparingly soluble in water are preferably used, for example conventional organic peroxides, such as dibenzoyl peroxide, ditert-butyl peroxide, tert-butyl hydroperoxide, cumyl hydroperoxide or biscyclohexyl peroxydicarbonate. For the postpolymerization, the reaction mixture is heated, for example, to a temperature which corresponds to the temperature at which the main polymerization was carried out or which is up to 20° C., preferably up to 10° C., higher. The main polymerization is complete when the polymerization initiator has been consumed or the monomer conversion is, for example, at least 98%, preferably at least 99.5%. tert-Butyl hydroperoxide is preferably used for the post-polymerization. The postpolymerization is carried out, for example, in a temperature range from 35 to 100° C., in general from 45 to 95° C.

After the end of the polymerization, a complexing agent for heavy metal ions can be added to the polymer dispersion in an amount such that all heavy metal ions are bound in complexed form. The starch-containing polymer dispersions comprise dispersed particles having a mean particle size of from 20 to 500 nm, preferably from 50 to 250 nm. The mean particle size can be determined by means of methods known to the person skilled in the art, such as, for example, laser correlation spectroscopy, ultracentrifuging or HDF (hydrodynamic fractionation). A further measure of the particle size of the dispersed polymer particles is the LT value. In order to determine the LT value (light transmittance), the polymer dispersion to be investigated in each case is measured in 0.1% strength by weight aqueous dilution in a cell of edge length 2.5 cm using light of 600 nm wavelength and compared with the corresponding transmittance of water under the same measuring conditions. The transmittance of water is specified as 100%. The more finely divided the dispersion, the higher is the LT value which is measured by the method described above. From the measured values, the mean particle size can be calculated, cf. B. Verner, M. Bárta, B. Sedlácek, Tables of Scattering Functions for Spherical Particles, Prague, 1976, Edice Marco, Rada D-DATA, SVAZEK D-1. The solid content of the starch-containing polymer dispersion is, for example, from 5 to 50% by weight and is preferably in the range from 15 to 40% by weight.

Preferred polymer dispersions are those which are prepared using
(a) from 40 to 60% by weight of acrylonitrile and/or methacrylonitrile,
(b) from 40 to 60% by weight of at least one C₁-C₁₂-alkyl acrylate and/or at least one C₁-C₁₂-alkyl methacrylate,
(c) from 0 to 20% by weight of at least one other ethylenically unsaturated copolymerisable monomer,
in which the sum of (a), (b) and (c) totals 100%,
and in which the aqueous polymer dispersion comprises,
(d) from 10 to 55%, such as 25 to 40%, by weight of an anionic or cationic degraded tapioca starch with a molar mass Mw of from 1,000 to 65,000 g/mol, in which the weight of (d) is based on the total solids of components (a), (b), (c) and (d) of the aqueous polymer dispersion.
and the polymerisation is carried out in the presence of at least 0.01% by weight, based on the weight of the ethylenically unsaturated monomers, of at least one terpene containing chain transfer agent.

More preferred dispersions of those which are prepared using
(a) from 40 to 60% by weight of acrylonitrile and/or methacrylonitrile,
(b) from 40 to 60% by weight of at least two of C₁-C₁₂-alkyl acrylate and/or C₁-C₁₂-alkyl methacrylate,
(c) from 0 to 20% by weight of at least one other ethylenically unsaturated copolymerisable monomer,
in which the sum of (a), (b) and (c) totals 100%,
and in which the aqueous polymer dispersion comprises,
(d) from 10 to 55%, such as 25 to 40%, by weight of an anionic or cationic degraded tapioca starch with a molar mass Mw of from 1,000 to 65,000 g/mol, in which the weight of (d) is based on the total solids of components (a), (b), (c) and (d) of the aqueous polymer dispersion,
and the polymerisation is carried out in the presence of at least 0.01% by weight, based on the weight of the ethylenically unsaturated monomers, of at least one terpene containing chain transfer agent.

Particularly preferred dispersions of those which are prepared using
(a) from 40 to 60% by weight of acrylonitrile and/or methacrylonitrile,
(b) from 40 to 60% by weight of at least two of C₁-C₁₂-alkyl acrylate and/or C₁-C₁₂-alkyl methacrylate comprising (b1) at least one C₁-C₄-alkyl acrylate and/or at least one C₁-C₄-alkyl methacrylate, and (b2) at least one C₅-C₁₂-alkyl acrylate and/or at least one C₅-C₁₂-alkyl methacrylate,
(c) from 0 to 20% by weight of at least one other ethylenically unsaturated copolymerisable monomer,
in which the sum of (a), (b) and (c) totals 100%,
and in which the aqueous polymer dispersion comprises,
(d) from 10 to 55%, such as 25 to 40%, by weight of an anionic or cationic degraded tapioca starch with a molar mass Mw of from 1,000 to 65,000 g/mol, in which the weight of (d) is based on the total solids of components (a), (b), (c) and (d) of the aqueous polymer dispersion,
and the polymerisation is carried out in the presence of at least 0.01% by weight, based on the weight of the ethylenically unsaturated monomers, of at least one terpene containing chain transfer agent.

From 40 to 60% by weight of n-butyl acrylate, sec-butyl acrylate, iso-butyl acrylate, tert-butyl acrylate and/or 2-ethylhexyl acrylate are particularly suitable as component (b) of the particularly preferred starch containing polymer dispersions.

It is particularly preferred that component (b1) is selected from n-butyl acrylate and/or tertiary butyl acrylate and component (b2) is 2-ethylhexyl acrylate.

It is particularly preferred that in the starch containing aqueous polymer dispersion the ratio of component (b1) to component (b2) is 10:1 to 1:1, preferably 5:1 to 2:1.

In further particularly preferred starch containing aqueous polymer dispersion the ethylenically unsaturated monomers comprise
(a) from 40 to 60% by weight of acrylonitrile and/or methacrylonitrile,
(b) from 40 to 60% by weight of at least two of C₁-C₄-alkyl acrylate and/or C₁-C₄-alkyl methacrylate,
(c) from 0 to 20% by weight of at least one other ethylenically unsaturated copolymerisable monomer,
   in which the sum of (a), (b) and (c) totals 100%,
   and in which the aqueous polymer dispersion comprises,
(d) from 10 to 55%, such as 25 to 40%, by weight of an anionic or cationic degraded tapioca starch with a molar mass Mw of from 1,000 to 65,000 g/mol, in which the weight of (d) is based on the total solids of components (a), (b), (c) and (d) of the aqueous polymer dispersion,
   and the polymerisation is carried out in the presence of at least 0.01% by weight, based on the weight of the ethylenically unsaturated monomers, of at least one terpene containing chain transfer agent.

In the further preferred form component (b) is desirably a mixture of n-butyl acrylate and/or tertiary butyl acrylate.

The starch-containing polymer dispersions described above are used as sizes for paper, board and cardboard. They can be used both as surface size and as engine size in the respective conventional amounts. The use as surface size is preferred. The dispersions according to the invention can be processed by all methods suitable for surface sizing. For the application, the dispersion is usually added to the size press liquor in an amount of from 0.05 to 5% by weight, based on solid substance, and depends on the desired degree of sizing of the papers to be finished. Furthermore, the size press liquor may comprise further substances, such as, for example, starch, pigments, optical brighteners, biocides, strength agents for paper, fixing agents, antifoams, retention aids and/or drainage aids. The application to the paper may be effected by means of a size press or other application units, such as a film press, speedsizer or gate-roll.

The amounts of polymer which are applied to the surface of paper products are, for example, from 0.005 to 1.0 g/m², preferably from 0.01 to 0.5 g/m².

In some applications it may be desirable to also include alum into the ionic tapioca starch containing polymer dispersions. This may be particularly so when the ionic tapioca starch is a cationic tapioca starch. Suitable doses of alum can be between 0.01 and 5.0 g/L, for instance between 0.1 and 5.0 g/L and in particular between 0.5, 1.0, 2.0 or 3.0 g/L.

Unless otherwise evident from the context, the stated percentages in the examples are always percent by weight. The particle sizes were determined by means of a high performance particle sizer (HPPS) from Malvern using an He—Ne laser (633 nm) at a scattering angle of 173°.

The LT values were determined in 0.1% strength aqueous solution of the dispersion to be determined, using a DR/2010 apparatus from Hach at a wavelength of 600 nm.

The following examples illustrate the invention.

In the examples that follow LD value is the transmittance value of polymer dispersions in order to obtain a guide as to the mean particle diameter. The instrument used to determine LD value was a spectrophotometer DR/2010 from the Hach Company. The method involves diluting the polymer dispersion to a solids content of 0.01%. Then the light transmittance is measured and then compared to clear water.

### EXAMPLE 1

In a polymerization vessel which was equipped with a stirrer, reflux condenser, jacket heating and metering apparatus, 98.56 gr of cationic tapioca starch, Ehcat 69 from EMS (DS=0.060-0.070) was dispersed in 438 gr of demineralised water under nitrogen atmosphere and with stirring. Thereafter, 0.38 gr of 25% concentration by weight aqueous calcium acetate solution and 2.2 gr of 1% aqueous solution of commercially available α-amylase (Termamyl 120L from Novo Nordisk) were added and the mixture was heated to 85° C. in the course of 45-50 min of stirring. At a temperature of 85° C., 8.59 gr of α-amylase (Termamyl 120L) was charged into the vessel and mixed for 30 min. The enzymatic starch degradation was stopped by adding 8.6 gr of glacial acetic acid solution. After the addition of 1.95 gr of a 10% strength by weight aqueous iron II sulfate solution (FeSO4.7H2O), 5.6 gr of an 18% strength by weight aqueous hydrogen peroxide solution the reaction was allowed to run with stirring for 15 min. The reaction temperature was further maintained at 85° C. Afterwards, the feed of monomer and initiator was started simultaneously. The monomer emulsion mixture consisted of 43.8 gr of demineralised water, 0.4 gr of a 40% strength by weight aqueous solution of sodium alkane sulfonate (K30 from Bayer AG), 100 gr of Acrylonitrile, 80 gr of n-Butyl acrylate, 20 gr of 2-Ethyl hexyl acrylate and 0.79 gr terpinolene which were added at constant rate for 165 mins. Simultaneously the initiator feed 49.68 gr of 18% strength by weight aqueous hydrogen peroxide solution was added for 195 min. After the end of metering, the reaction mixture was stirred for another 30 minutes at 85° C. and then it is cooled down to 60° C. After 5.03 gr TBHP (tertiary butyl hydro peroxide) (10%) was added for 30 minute and then mixed for 15 min, followed by adding 5.1 gr Rongalit C (sodium formaldehyde sulfoxylate available from Wuxi Yuanhui Chemical Company Limited)(10%) for 60 min and then mixing it for 30 mins. Thereafter the reaction mixture was cooled down to room temperature. Then 2.58 gr Acticid MBS, (a biocide available from Thor Specialty Chemical Company) and 1.23 gr defoamer (Afranil T from BASF) were added. After filtration (125 μm), a finely divided dispersion was obtained having a solids content of 30% and LD (0.01%) of 96.1% and a particle size of 91.2 nm.

### EXAMPLE 2

In a polymerization vessel which was equipped with a stirrer, reflux condenser, jacket heating and metering apparatus, 138 gr of anionic oxidized tapioca starch (Ehstable 15 from EMS) was dispersed in 715 gr of demineralised water under nitrogen atmosphere and with stirring. Thereafter, 1.73 gr of 25% concentration by weight aqueous calcium acetate solution were added and the mixture was heated to 85° C. in the course of 45 min of stirring. At 85° C., 7.3 gr of 1% aqueous solution of commercially available α-amylase (Termamyl 120L from Novo Nordisk) was added and then mixed for 20 min. Afterwards, the enzymatic starch degradation was stopped by adding 13.19 gr of glacial acetic acid solution. After the addition of 2.62 gr of a 10% strength by weight aqueous iron II sulfate solution (FeSO4.7H2O), 4.52 gr of an 18% strength by weight aqueous hydrogen peroxide solution the reaction was allowed to run with stirring for 15 min. The reaction temperature is further maintained at 85° C. Afterwards, the feeding of monomer and initiator into the vessel was started simultaneously. The monomer emulsion mixture consisted of 68 gr of demineralised water, 0.53 gr of a 40% strength by weight aqueous solution of sodium alkane sulfonate (K30 from Bayer AG), 152.3 gr of acrylonitrile, 121.8 gr of n-Butyl acrylate, 30.45 gr of 2-ethyl hexyl acrylate and 1.19 gr terpinolene which were added at constant rate for 165 mins. Simultaneously the initiator feed 58.57 gr of 18% strength by weight aqueous hydrogen peroxide solution was added for 195 min. After the end of metering, the reaction mixture was stirred for another 30 minutes at 85° C. and then it was cooled down to 60° C. After 8.68 gr TBHP (tertiary butyl hydro peroxide) (10%) was added for 30 minutes and then mixed for 15 min, followed by adding 15.53 gr Rongalit C (sodium formaldehyde sulfoxylate available from Wuxi Yuanhui Chemical Company Limited) (10%) for 60 min and then mixing it for 30 mins. Thereafter the reaction mixture was cooled down to room temperature. 1.55 gr Trilon B (Chelating agent, from BASF) was added and then the pH was adjusted to 4.5-5.5 using 25% strength Sodium Hydroxide. Afterwards, 2.58 gr biocide (Acticid MBS, Thor Specialty Chemical Company) and 0.12 gr defoamer (Afranil T from BASF) were added. After filtration (125 μm), a finely divided dispersion was obtained having a solids content of 30% and LD (0.01%) of 95.7% and a particle size of 101 nm.

### EXAMPLE 3

In a polymerization vessel which was equipped with a stirrer, reflux condenser, jacket heating and metering apparatus, 141.4 gr of anionic oxidized tapioca starch (Ehstable 15 from EMS) was dispersed in 715 gr of demineralised water under nitrogen atmosphere and with stirring. Thereafter, 1.73 gr of 25% concentration by weight aqueous calcium acetate solution were added and the mixture was heated to 85° C. in the course of 45 min of stirring. At 85° C., 8.22 gr of 1% aqueous solution of commercially available α-amylase (Termamyl 120L from Novo Nordisk) was added and then mixed for 20 min. Afterwards, the enzymatic starch degradation was stopped by adding 13.19 gr of glacial acetic acid solution. After the addition of 2.62 gr of a 10% strength by weight aqueous iron II sulfate solution (FeSO4.7H2O), 4.52 gr of an 18% strength by weight aqueous hydrogen peroxide solution was allowed to run with stirring for 15 min. The reaction temperature was further maintained at 85° C. Afterwards, the feeding of monomer and initiator was started simultaneously. The monomer emulsion mixture consisted of 68 gr of demineralised water, 0.53 gr of a 40% strength by weight aqueous solution of sodium alkane sulfonate (K30 from Bayer AG), 152.3 gr of acrylonitrile, 121.8 gr of n-Butyl acrylate, 30.45 gr of 2-ethyl hexyl acrylate which were added at constant rate for 165 mins. Simultaneously the initiator feed 58.57 gr of 18% strength by weight aqueous hydrogen peroxide solution was added over 195 min. After the end of metering, the reaction mixture was stirred for another 30 minutes at 85° C. and then it was cooled down to 60° C. After 8.68 gr TBHP (tertiary butyl hydro peroxide) (10%) was added for 30 minute and then the reaction mixture was mixed for 15 min, followed by adding 15.53 gr Rongalit C (sodium formaldehyde sulfoxylate available from Wuxi Yuanhui Chemical Company Limited) (10%) for 60 min and then mixing it for 30 mins. Thereafter the reaction mixture was cooled down to room temperature. Add 1.55 gr Trilon B (Chelating agent, from BASF) and then adjust the pH: 4.5-5.5 using 25% strength Sodium Hydroxide. Afterwards, 2.58 gr biocide (Acticid MBS from Thor Specialty Chemical Company) and 0.12 gr defoamer (Afranil T from BASF) were added. After filtration (125 μm), a finely divided dispersion was obtained having a solids content of 30% and LD (0.01%) of 95.1% and a particle size of 112 nm.

### Comparative Example 1: (US Patent 2012/0180970)

In a polymerization vessel which was equipped with a stirrer, reflux condenser, jacket heating and metering apparatus, 87.32 gr of anionic oxidized tapioca starch (Ehstable 15 from EMS) was dispersed in 872 gr of demineralised water under nitrogen atmosphere and with stirring. Then the mixture was heated to 80° C. in the course of 45 min of stirring. At 80 C, 5.58 gr of 1% aqueous solution of commercially available α-amylase (Termamyl 120L from Novo Nordisk) was added and then mixed for 20 min. Afterwards, the enzymatic starch degradation was stopped by adding 0.472 gr of glacial acetic acid solution (60%). Afterwards 3.63 gr of a 10% strength by weight aqueous iron II sulfate solution (FeSO4.7H2O) was added. The reaction temperature was further increased to 85° C. At 85° C., the feeding of monomer and initiator was started simultaneously. The monomer emulsion mixture consisted of 128 gr of demineralised water, 0.64 gr of a 40% strength by weight aqueous solution of sodium alkane sulfonate (K30 from Bayer AG), 117 gr of styrene, 58.25 gr of n-Butyl acrylate, 1.90 acrylic acid and 0.77 gr terpinolene (95%) which were added at constant rate for 120 mins. Simultaneously the initiator feed 43.138 gr of 10% strength by weight aqueous hydrogen peroxide solution was added over 150 min. After the end of metering, the reaction mixture was stirred for another 30 minutes at 85° C. and then it was cooled down to 60° C. After 2.54 gr TBHP (tertiary butyl hydro peroxide) (10%) was added for 30 minute and then mixed for 15 min. Thereafter the reaction mixture was cooled down to room temperature. 2.42 gr formalin was added followed by the addition of 1.3 gr biocide (Acticid MBS from Thor Specialty Chemical Company) After filtration (125 μm), a finely divided dispersion was obtained having a solids content of 30% and LD (0.01%) of 95.8% and a particle size of 89 nm.

### Comparative Example 2: European Patent (EP) 0276 770 B2

In a polymerization vessel which was equipped with a stirrer, reflux condenser, jacket heating and metering apparatus, 141.11 gr of anionic oxidized Potato starch (Amylex 15 from Sud Chemie) was dispersed in 715 gr of demineralised water under nitrogen atmosphere and with stirring. Thereafter, 1.73 gr of 25% concentration by weight aqueous calcium acetate solution were added and the mixture was heated to 85° C. in the course of 45 min of stirring. At 85° C., 7.3 gr of 1% aqueous solution of commercially-α-amylase (Termamyl 120L from Novo Nordisk) was added and then mixed for 20 min. Afterwards, the enzymatic starch degradation was stopped by adding 13.19 gr of glacial acetic acid solution. After the addition of 2.62 gr of a 10% strength by weight aqueous iron II sulfate solution (FeSO4.7H2O), 4.52 gr of an 18% strength by weight aqueous hydrogen peroxide solution the reaction was allowed to run with stirring for 15 min. The reaction temperature is further maintained at 85° C. Afterwards, the feeding of monomer and initiator was started simultaneously. The monomer emulsion mixture consisted of 68 gr of demineralised water, 0.53 gr of a 40% strength by weight aqueous solution of sodium alkane sulfonate (K30 from Bayer AG), 167.48 gr of acrylonitrile, 137.03 gr of n-Butyl acrylate were added at constant rate for 165 mins. Simultaneously the initiator feed 48.57 gr of 18% strength by weight aqueous hydrogen peroxide solution was added for 195 min. After the end of metering, the reaction mixture was stirred for another 30 minutes at 85° C. and then it was cooled down to 60° C. After 8.68 gr TBHP (tertiary butyl hydro peroxide) (10%) was added for 30 minute and then mixed for 15 min, followed by adding 15.53 gr Rongalit C (sodium formaldehyde sulfoxylate available from Wuxi Yuanhui Chemical Company Limited) (10%) for 60 min and then mixing it for 30 mins. Thereafter the reaction mixture was cooled down to room temperature. 1.55 gr Trilon B was added and then the pH was adjusted to 4.5-5.5 using 25% strength Sodium Hydroxide. Afterwards, 2.58 gr biocide (Acticid MBS from Thor Specialty Chemical Company) and 0.12 gr defoamer (Afranil T from BASF) were added. After filtration (125 μm), a finely divided dispersion was obtained having a solids content of 30% and LD (0.01%) of 93.8% and a particle size of 115 nm.

### Comparative Example 3 (US Patent 2012/0180970)

In a polymerization vessel which was equipped with a stirrer, reflux condenser, jacket heating and metering apparatus, 89.82 gr of anionic oxidized Potato starch (Amylex 15 from Sud Chemie) was dispersed in 893 gr of demineralised water under nitrogen atmosphere and with stirring. Then the mixture was heated to 80° C. in the course of 45 min of stirring. At 80° C., 5.63 gr of 1% aqueous solution of commercially available α-amylase (Termamyl 120L from Novo Nordisk) was added and then mixed for 20 min. Afterwards, the enzymatic starch degradation was stopped by adding 0.872 gr of glacial acetic acid solution (60%). 3.65 gr of a 10% strength by weight aqueous iron II sulfate solution (FeSO4.7H2O) was then added. The reaction temperature was further increased to 85° C. At 85° C., the feeding of monomer and initiator was started simultaneously. The monomer emulsion mixture consisted of 128 gr of demineralised water, 0.65 gr of a 40% strength by weight aqueous solution of sodium alkane sulfonate (K30 from Bayer AG), 117 gr of styrene, 58.25 gr of n-Butyl acrylate, 1.90 acrylic acid and 0.78 gr terpinolene (95%) were added at constant rate for 120 mins. Simultaneously the initiator feed 43.39 gr of 10% strength by weight aqueous hydrogen peroxide solution was added over 150 min. After the end of metering, the reaction mixture was stirred for another 30 minutes at 85° C. and then it was cooled down to 60° C. After 2.84 gr TBHP (tertiary butyl hydro peroxide) (10%) was added for 30 minutes and then the reaction mixture was mixed for 15 min. Thereafter the reaction mixture was cooled down to room temperature. 2.39 gr formalin and then 1.3 gr biocide (Acticid MBS from Thor Specialty Chemical Company) were added. After filtration (125 μm), a finely divided dispersion was obtained having a solids content of 30% and LD (0.01%) of 96.3% and a particle size of 86 nm.

The application test work was carried out on liner paper by passing the liner paper through the size press containing the respective compositions of the examples as sizing solutions. The respective sizing solution was used to wet size the liner paper and was then dried using the drying calendar at a temperature of 120° C. Afterwards, the size of paper was put in a conditioning humidity room for at least eight hours before making the Cobb 60 measurement. The results are presented in Tables 1 and 2.

TABLE 1
Application Test on Liner Paper (Based weight (BW): 150 gsm)

| | Blank | Ex1 | | Ex2 | | Ex 3 | | Comp1 | | Comp2 | | Comp3 | |
|---|---|---|---|---|---|---|---|---|---|---|---|---|---|
| Concentration | 6 | 6 | | 6 | | 6 | | 6 | | 6 | | 6 | |
| of Oxidised | | | | | | | | | | | | | |
| Tapioca | | | | | | | | | | | | | |
| Starch (%) | | | | | | | | | | | | | |
| PSA Dosage | 0 | 1.5 | 2.0 | 1.5 | 2.0 | 1.5 | 2.0 | 1.5 | 2.0 | 1.5 | 2.0 | 1.5 | 2.0 |
| (g/l) | | | | | | | | | | | | | |
| Cobb60 | 131 | 70 | 36 | 77 | 40 | 89 | 51 | 108 | 103 | 96 | 81 | 113 | 106 |
| (g/m2) | | | | | | | | | | | | | |

TABLE 2
Application Test on Liner Paper (Bw: 150 gsm)

| | Blank | Ex1 | | Ex2 | | Ex 3 | | Comp1 | | Comp2 | | Comp3 | |
|---|---|---|---|---|---|---|---|---|---|---|---|---|---|
| Concentration | 6 | 6 | | 6 | | 6 | | 6 | | 6 | | 6 | |
| of OxidiSed | | | | | | | | | | | | | |
| Tapioca | | | | | | | | | | | | | |
| Starch (%) | | | | | | | | | | | | | |
| Alun (g/l) | 1.0 | 1.0 | | 1.0 | | 1.0 | | 1.0 | | 1.0 | | 1.0 | |
| PSA Dosage | 0 | 1.5 | 2.0 | 1.5 | 2.0 | 1.5 | 2.0 | 1.5 | 2.0 | 1.5 | 2.0 | 1.5 | 2.0 |
| (g/l) | | | | | | | | | | | | | |
| Cobb60 | 130 | 35 | 25 | 40 | 24 | 52 | 36 | 80 | 53 | 63 | 39 | 95 | 73 |
| (g/m2) | | | | | | | | | | | | | |

For determining the degree of sizing of the surface-sized papers, the Cobb₆₀ value according to DIN EN 20 535 was determined. The water absorbing of the paper sheet in g/m² after contact with water and a contact time of 60 s is defined as the Cobb₆₀ value. The lower the Cobb₆₀ value, the better is the sizing effect of the dispersion used.

### EXAMPLE 4

In a polymerization vessel which equipped with a stirrer, reflux condenser, jacket heating and metering apparatus, 98.56 gr of cationic tapioca starch, Ehcat 69 (DS=0.060-0.070) (available from EMS) were dispersed in 438 gr of demineralised water under nitrogen atmosphere and with stirring. Thereafter, 0.38 gr of 25% concentration by weight aqueous calcium acetate solution and 2.2 gr of 1% aqueous solution of commercially available α-amylase (Termamyl 120L from Novo Nordisk) were added and the mixture was heated to 85° C. in the course of 45-50 min of stirring. At a temperature of 85° C., 8.59 gr of α-amylase (Termamyl 120L) was charged into the vessel and mixed for 30 min. The enzymatic starch degradation was stopped by adding 8.6 gr of glacial acetic acid solution. After the addition of 1.95 gr of a 10% strength by weight aqueous iron II sulfate solution (FeSO4.7H2O), 5.6 gr of an 18% strength by weight aqueous hydrogen peroxide solution was added with stirring for 15 min. The reaction temperature was further maintained at 85° C. Afterwards, the feeding of monomer and initiator was started simultaneously. The monomer emulsion mixture consisted of 43.8 gr of demineralised water, 0.4 gr of a 40% strength by weight aqueous solution of sodium alkane sulfonate (K30 from Bayer AG), 100 gr of Acrylonitrile, 80 gr of n-Butyl acrylate, 20 gr of 2-Ethyl hexyl acrylate and 0.79 gr terpinolene was added at constant rate for 165 mins. Simultaneously the initiator feed 49.68 gr of 18% strength by weight aqueous hydrogen peroxide solution was added for 195 min. After the end of metering, the reaction mixture was stirred for another 30 minutes at 85° C. and then it is cooled down to 60° C. After 5.03 gr TBHP (tertiary butyl hydro peroxide) (10%) was added for 30 minute and then mixed for 15 min, followed by adding 5.1 gr Rongalit C (sodium formaldehyde sulfoxylate available from Wuxi Yuanhui Chemical Company Limited) (10%) for 60 min and then mixed for 30 mins. Thereafter the reaction mixture was cooled down to room temperature. Then add 2.58 gr biocide (Acticid MBS from Thor Specialty Chemical Company) and 1.23 gr defoamer (Afranil T available from BASF). After filtration (125 μm), a finely divided dispersion was obtained having a solids content of 30% and LD (0.01%) of 96.1% and a particle size of 91.2 nm.

### EXAMPLE 5

In a polymerization vessel which was equipped with a stirrer, reflux condenser, jacket heating and metering apparatus, 98.56 gr of cationic tapioca starch, Ehcat 69 (DS=0.060-0.071) (from EMS) was dispersed in 438 gr of demineralised water under nitrogen atmosphere and with stirring. Thereafter, 0.38 gr of 25% concentration by weight aqueous calcium acetate solution and 2.2 gr of 1% aqueous solution of commercially available α-amylase (Termamyl 120L from Novo Nordisk) were added and the mixture was heated to 85° C. in the course of 45-50 min of stirring. At a temperature of 85° C., 8.59 gr of α-amylase (Termamyl 120L) was charged into the vessel and mixed for 30 min. The enzymatic starch degradation was stopped by adding 8.6 gr of glacial acetic acid solution. After the addition of 1.95 gr of a 10% strength by weight aqueous iron II sulfate solution (FeSO4.7H2O), 5.6 gr of an 18% strength by weight aqueous hydrogen peroxide solution was added with stirring for 15 min. The reaction temperature was further maintained at 85° C. Afterwards, the feed of monomer and initiator was started simultaneously. The monomer emulsion mixture consisted of 43.8 gr of demineralised water, 0.4 gr of a 40% strength by weight aqueous solution of sodium alkane sulfonate (K30 from Bayer AG), 100 gr of Acrylonitrile, 80 gr of n-Butyl acrylate, 20 gr of 2-Ethyl hexyl acrylate and 1.60 gr terpinolene was added at constant rate for 165 mins. Simultaneously the initiator feed 49.68 gr of 18% strength by weight aqueous hydrogen peroxide solution was added for 195 min. After the end of metering, the reaction mixture was stirred for another 30 minutes at 85° C. and then it is cooled down to 60° C. After 5.03 gr TBHP (tertiary butyl hydro peroxide) (10%) were added for 30 minutes and then mixed for 15 min, followed by adding 5.1 gr Rongalit C (sodium formaldehyde sulfoxylate available from Wuxi Yuanhui Chemical Company Limited) (10%) for 60 min and then mixed for 30 mins. Thereafter the reaction mixture was cooled down to room temperature. 2.58 gr biocide (Acticid MBS from Thor Specialty Chemical Company) and 1.23 gr defoamer (Afranil T available from BASF) were then added. After filtration (125 μm), a finely divided dispersion was obtained having a solids content of 30% and LD (0.01%) of 96.6% and a particle size of 87.1 nm

### EXAMPLE 6

In a polymerization vessel which was equipped with a stirrer, reflux condenser, jacket heating and metering apparatus, 98.56 gr of cationic tapioca starch, Ehcat 69 (DS=0.060-0.070) was dispersed in 438 gr of demineralised water under nitrogen atmosphere and with stirring. Thereafter, 0.38 gr of 25% concentration by weight aqueous calcium acetate solution and 2.2 gr of 1% aqueous solution of commercially available α-amylase (Termamyl 120L from Novo Nordisk) were added and the mixture was heated to 85° C. in the course of 45-50 min of stirring. At a temperature of 85° C., 8.59 gr of α-amylase (Termamyl 120L) was charged into the vessel and mixed for 30 min. The enzymatic starch degradation was stopped by adding 8.6 gr of glacial acetic acid solution. After the addition of 1.95 gr of a 10% strength by weight aqueous iron II sulfate solution (FeSO4.7H2O), 5.6 gr of an 18% strength by weight aqueous hydrogen peroxide solution was added with stirring for 15 min. The reaction temperature was further maintained at 85° C. Afterwards, the feeding of monomer and initiator was started simultaneously. The monomer emulsion mixture consisted of 43.8 gr of demineralised water, 0.4 gr of a 40% strength by weight aqueous solution of sodium alkane sulfonate (K30 from Bayer AG), 100 gr of Acrylonitrile, 80 gr of n-Butyl acrylate, 20 gr of 2-Ethyl hexyl acrylate (no terpinolene) were added at constant rate for 165 mins. Simultaneously the initiator feed 49.68 gr of 18% strength by weight aqueous hydrogen peroxide solution was added for 195 min. After the end of metering, the reaction mixture was stirred for another 30 minutes at 85° C. and then it was cooled down to 60° C. After 5.03 gr TBHP (tertiary butyl hydro peroxide) (10%) was added for 30 minute and then mixed for 15 min, followed by adding 5.1 gr Rongalit C (sodium formaldehyde sulfoxylate available from Wuxi Yuanhui Chemical Company Limited) (10%) for 60 min and then mixing it for 30 mins. Thereafter the reaction mixture was cooled down to room temperature. 2.58 gr biocide (Acticid MBS from Thor Specialty Chemical Company) and 1.23 gr defoamer (Afranil T available from BASF) and then added. After filtration (125 μm), a finely divided dispersion was obtained having a solids content of 30% and LD (0.01%) of 94.1% and a particle size of 101 nm.

### Comparative Example 4 (Patent EP 0276 770 B2 Date 22 Jan. 88)

In a polymerization vessel which was equipped with a stirrer, reflux condenser, jacket heating and metering apparatus, 163.51 gr of cationic Potato starch (DS=0.045) was dispersed in 1010 gr of demineralised water under nitrogen atmosphere and with stirring. Thereafter, 0.32 gr of 25% concentration by weight aqueous calcium acetate solution and 32 gr of 1% aqueous solution of commercially available α-amylase (Termamyl 120L from Novo Nordisk) were added and the mixture was heated to 85° C. in the course of 45 min of stirring. After further 30 minutes, the enzymatic starch degradation was stopped by adding 30.38 gr of glacial acetic acid solution. After the addition of 6.41 gr of a 10% strength by weight aqueous iron II sulfate solution (FeSO4.7H2O), 8.48 gr of an 10% strength by weight aqueous hydrogen peroxide solution was allowed to run with stirring for 15 min. The reaction temperature is further maintained at 85° C. Afterwards, the feeding of monomer and initiator was started simultaneously. The monomer emulsion mixture consisted of 100.0 gr of demineralised water, 1.0 gr of a 40% strength by weight aqueous solution of sodium alkane sulfonate (K30 from Bayer AG), 298.5 gr of acrylonitrile, 366.38 gr of n-Butyl acrylate were added for 165 min. Simultaneously the initiator feed 88.12 gr of 10% strength by weight aqueous hydrogen peroxide solution was added over 215 min. After the end of metering, the reaction mixture was stirred for another 60 minutes at 85° C. and then it is cooled down to 60° C. After 2.53 gr TBHP (tertiary butyl hydro peroxide) (10%) were added for 30 minute the reaction mixture was mixed for 15 min, followed by adding 5.0 gr Rongalit C (sodium formaldehyde sulfoxylate available from Wuxi Yuanhui Chemical Company Limited) (10%) for 10 min and then mixing it for 30 mins. Thereafter the reaction mixture was cooled down to room temperature. 7.2 gr biocide (Acticid MBS from Thor Specialty Chemical Company) and 0.25 defoamer (Afranil T from BASF) were then added. After filtration (125 μm), a finely divided dispersion was obtained having a solids content of 30% and LD (0.01%) of 91.8% and a particle size of 120 nm.

### Comparative Example 5 (Corresponding to Example 1 According to US Patent 2009/0139675)

In a polymerization vessel which was equipped with a stirrer, reflux condenser, jacket heating and metering apparatus, 104.9 gr of cationic Potato starch (DS=0.065-0.07) was dispersed in 395 gr of demineralised water under nitrogen atmosphere and with stirring. Thereafter, 1.16 gr of 25% concentration by weight aqueous calcium acetate solution and 11.6 gr of 1% aqueous solution of commercially available α-amylase (Termamyl 120L from Novo Nordisk) were added and the mixture was heated to 85° C. in the course of 45 min of stirring. After further 30 minutes, the enzymatic starch degradation was stopped by adding 5.9 gr of glacial acetic acid solution. After the addition of 1.14 gr of a 10% strength by weight aqueous iron II sulfate solution (FeSO4.7H2O), 5.28 gr of an 18% strength by weight aqueous hydrogen peroxide solution was added to the reaction mixture with stirring for 15 min. The reaction temperature was further maintained at 85° C. Afterwards, the feeding of monomer and initiator was started simultaneously. The monomer emulsion mixture consisted of 90.0 gr of demineralised water, 0.2 gr of a 40% strength by weight aqueous solution of sodium alkane sulfonate (K30 from Bayer AG), 140 gr of styrene and 60 gr of n-Butyl acrylate were added at constant rate for 120 mins. Simultaneously the initiator feed 46.11 gr of 18% strength by weight aqueous hydrogen peroxide solution was added for 150 min. After the end of metering, the reaction mixture was stirred for another 30 minutes at 85 C. After 6.20 gr of 10% strength TBHP (tertiary butyl hydro peroxide) was added for 30 minute and then mixed for 30 min. following this 8.20 gr TBHP (10%) was added over 30 min. Thereafter the reaction mixture was cooled down to room temperature. 0.95 gr EDTA (40%) was added and the pH was adjusted to 6 by addition of 15.63 gr NaOH (25%). After filtration (125 μm), a finely divided dispersion was obtained having a solids content of 30% and LD (0.01%) of 94.6% and an average particle size (Dz) 81 nm.

### Comparative Example 6 (Corresponding to Example 3 According to Example EP-B-1 056 783)

In a polymerization vessel which was equipped with a stirrer, reflux condenser, jacket heating and metering apparatus, 78.1 gr of oxidative degraded potato starch (Perfectamyl A4692 from Avebe) was dispersed in 500 gr of demineralised water under nitrogen atmosphere and with stirring. Thereafter, 1.16 gr of 25% concentration by weight aqueous calcium acetate solution and 11.6 gr of 1% aqueous solution of commercially available α-amylase (Termamyl 120L from Novo Nordisk) were added and the mixture was heated to 85° C. in the course of 45 min of stirring. After further 30 minutes, the enzymatic starch degradation was stopped by adding 5.9 gr of glacial acetic acid solution. After the addition of 27 gr of a 1% strength by weight aqueous iron II sulfate solution (FeSO4.7H2O), 73 gr of an 3% strength by weight aqueous hydrogen peroxide solution was added to the mixture with stirring for 15 min. The reaction temperature was further maintained at 85 C. Afterwards, the feeding of monomer and initiator was started simultaneously. The monomer emulsion mixture consisted of 90.0 gr of demineralised water, 0.2 gr of a 40% strength by weight aqueous solution of sodium alkane sulfonate (K30 from Bayer AG), 104 gr of styrene, 42.6 gr of n-Butyl acrylate, 42.6 gr of t-Butyl acrylate, and 10.6 acrylic acid which were added at constant rate for 120 mins. Simultaneously the initiator feed 59 gr of 3% strength by weight aqueous hydrogen peroxide solution was added for 150 min. After the end of metering, the reaction mixture was stirred for another 30 minutes at 85° C. After 0.75 gr of 70% strength TBHP (tertiary butyl hydro peroxide) was added for 30 minute and then mixed for 30 min and the pH was adjusted to 6.5 using ammonia. After filtration (125 μm), a finely divided dispersion was obtained having a solids content of 24.1% and LD (0.01%) of 90.1% and an average particle size (Dz) 85 nm.

The application test work was carried out on liner paper by passing the liner paper through the size press containing the respective compositions of the examples as sizing solutions. The respective sizing solution was used to wet size the liner paper and was dried using the drying calendar at a temperature of 120° C. Afterwards, the size of paper was put in a conditioning humidity room for at least eight hours before making the Cobb measurement. The results are presented in Table 3.

TABLE 3
Application Test on Liner Paper

| | Blank | Ex4 | | Ex5 | | Ex6 | | Comp4 | | Comp5 | | Comp6 | |
|---|---|---|---|---|---|---|---|---|---|---|---|---|---|
| Concentration | 6 | 6 | | 6 | | 6 | | 6 | | 6 | | 6 | |
| of Tapioca | | | | | | | | | | | | | |
| Starch (%) | | | | | | | | | | | | | |
| PSA Dosage | 0 | 1.5 | 2.5 | 1.5 | 2.5 | 1.5 | 2.5 | 1.5 | 2.5 | 1.5 | 2.5 | 1.5 | 2.5 |
| (g/l) | | | | | | | | | | | | | |
| Cobb60 | 128 | 59 | 32 | 55 | 30 | 69 | 41 | 73 | 49 | 115 | 101 | 105 | 89 |
| (g/m2) | | | | | | | | | | | | | |

TABLE 4
Application Test on Liner Paper

| | Blank | Ex4 | | Ex5 | | Ex6 | | Comp4 | | Comp5 | | Comp6 | |
|---|---|---|---|---|---|---|---|---|---|---|---|---|---|
| Concentration | 6 | 6 | | 6 | | 6 | | 6 | | 6 | | 6 | |
| of Tapioca | | | | | | | | | | | | | |
| Starch (%) | | | | | | | | | | | | | |
| Alun (g/l) | 1.0 | 1.0 | | 1.0 | | 1.0 | | 1.0 | | 1.0 | | 1.0 | |
| PSA Dosage | 0 | 1.5 | 2.5 | 1.5 | 2.5 | 1.5 | 2.5 | 1.5 | 2.5 | 1.5 | 2.5 | 1.5 | 2.5 |
| (g/l) | | | | | | | | | | | | | |
| Cobb60 | 131 | 30 | 23 | 32 | 23 | 45 | 29 | 72 | 41 | 92 | 80 | 87 | 68 |
| (g/m2) | | | | | | | | | | | | | |

TABLE 5
Application Test on Semi-sized wood free paper

| | Blank | Ex4 | | Comp4 | | Comp5 | |
|---|---|---|---|---|---|---|---|
| Concentration | 6 | 6 | | 6 | | 6 | |
| of Tapioca | | | | | | | |
| Starch (%) | | | | | | | |
| PSA Dosage | 0 | 0.5 | 1.0 | 0.5 | 1.0 | 0.5 | 1.0 |
| (g/l) | | | | | | | |
| Cobb60 | 104 | 59 | 32 | 68 | 50 | 69 | 41 |
| (g/m2) | | | | | | | |

For determining the degree of sizing of the surface-sized papers, the Cobb₆₀ value according to DIN EN 20 535 was determined. The water absorbing of the paper sheet in g/m² after contact with water and a contact time of 60 s is defined as the Cobb₆₀ value. The lower the Cobb₆₀ value, the better is the sizing effect of the dispersion used.

### EXAMPLE 7

In a polymerization vessel which equipped with a stirrer, reflux condenser, jacket heating and metering apparatus, 98.56 gr of cationic tapioca starch, Ehcat 69 (DS=0.060-0.070) were dispersed in 438 gr of demineralised water under nitrogen atmosphere and with stirring. Thereafter, 0.38 gr of 25% concentration by weight aqueous calcium acetate solution and 5.6 gr of 1% aqueous solution of commercially available α-amylase (Termamyl 120L from Novo Nordisk) were added and the mixture was heated to 85° C. in the course of 45-50 min of stirring. At a temperature of 85° C., 8.59 gr of α-amylase (Termamyl 120L) was charged into the vessel and mixed for 30 min. The enzymatic starch degradation was stopped by adding 8.6 gr of glacial acetic acid solution. After the addition of 1.95 gr of a 10% strength by weight aqueous iron II sulfate solution (FeSO4.7H2O), 5.6 gr of an 18% strength by weight aqueous hydrogen peroxide solution was added to the mixture with stirring for 15 min. The reaction temperature was further maintained at 85° C. Afterwards, the feeding of monomer and initiator was started simultaneously. The monomer emulsion mixture consisted of 43.8 gr of demineralised water, 0.4 gr of a 40% strength by weight aqueous solution of sodium alkane sulfonate (K30 from Bayer AG), 100 gr of Acrylonitrile, 40 gr of n-Butyl acrylate, 60 gr of tert-Butyl acrylate and 1.18 gr terpinolene were added at constant rate for 165 mins. Simultaneously the initiator feed 49.68 gr of 18% strength by weight aqueous hydrogen peroxide solution was added for 195 min. After the end of metering, the reaction mixture was stirred for another 30 minutes at 85° C. and then it is cooled down to 60° C. Subsequently 5.03 gr TBHP (tertiary butyl hydro peroxide) (10%) was added for 30 minute and then mixed for 15 min, followed by adding 5.1 gr Rongalit C (sodium formaldehyde sulfoxylate available from Wuxi Yuanhui Chemical Company Limited) (10%) for 60 min and then mixing it for 30 mins. Thereafter the reaction mixture was cooled down to room temperature. 2.58 gr biocide (Acticid MBS from Thor Specialty Chemical Company) and 1.23 gr defoamer (Afranil T available from BASF) were then added. After filtration (125 μm), a finely divided dispersion was obtained having a solids content of 30% and LD (0.01%) of 96.6% and a particle size of 89.7 nm.

The application test work was carried out on liner paper by passing the liner paper through the size press containing the respective compositions of the examples as sizing solutions. The respective sizing solution was used to wet size the liner paper and was dried using the drying calendar at a temperature of 120° C. Afterwards, the size of paper was put in a conditioning humidity room for at least eight hours before making the Cobb measurement. The results are presented in Table 3.

TABLE 6
Application Test on Liner Paper

| | Blank | Ex4 | | Ex7 | |
|---|---|---|---|---|---|
| Concentration of Tapioca | 6 | 6 | | 6 | |
| Starch (%) | | | | | |
| PSA Dosage (g/l) | 0 | 2.0 | 3.0 | 2.0 | 3.0 |
| Cobb60 (g/m2) | 133 | 62 | 35 | 63 | 32 |

TABLE 7
Application Test on Liner Paper

| | Blank | Ex4 | | Ex7 | |
|---|---|---|---|---|---|
| Concentration of Tapioca | 6 | 6 | | 6 | |
| Starch (%) | | | | | |
| Alun (g/l) | 1.0 | 1.0 | | 1.0 | |
| PSA Dosage (g/l) | 0 | 1.0 | 2.0 | 1.0 | 2.0 |
| Cobb60 (g/m2) | 133 | 39 | 23 | 35 | 22 |

For determining the degree of sizing of the surface-sized papers, the Cobb₆₀ value according to DIN EN 20 535 was determined. The water absorbing of the paper sheet in g/m² after contact with water and a contact time of 60 s is defined as the Cobb₆₀ value. The lower the Cobb₆₀ value, the better is the sizing effect of the dispersion used.

### EXAMPLE 8

24 finely divided polymer dispersions were prepared by a method and analogous to Example 1 using cationic tapioca starch of different degrees of substitution: Ehcat 35 from EMS (DS=0.035-0.040), Ehcat 50 from EMS (DS=0.050-0.055), and Ehcat 69 from EMS (DS=0.060-0.070). Tables 8-13 indicate the dose of the respective cationic tapioca starch; the amount of alum (where this is included in the dispersion); the viscosity and pH of the respective dispersion.

The application test work was carried out on liner paper by passing the liner paper through the size press containing the respective compositions of the examples as sizing solutions. The respective sizing solution was used to wet size the liner paper and was dried using the drying calendar at a temperature of 120° C. Afterwards, the size of paper was put in a conditioning humidity room for at least eight hours before making the Cobb 60 measurement. The results are presented in Table 8-13.

TABLE 8

| Test | | | Blank | 1 | 2 | 3 | 4 |
|---|---|---|---|---|---|---|---|
| Concentration of Excel | | % | 6 | 6 | 6 | 6 | 6 |
| Size 22 starch Solution | | | | | | | |
| Ehcat 35 | DS | g/L | 0 | 1.5 | 2.0 | 3.0 | 4.0 |
| | 0.035-0.040 | | | | | | |

| | | | | | | |
|---|---|---|---|---|---|---|
| pH | | 7.51 | 6.05 | 5.82 | 5.51 | 5.32 |
| Viscosity | m · | 17 | 17 | 17 | 17 | 17 |
| | Pa · S | | | | | |
| Pick up | % | 5.31 | 5.22 | 5.32 | 5.34 | 5.32 |
| Cobb 60″ | g/m2 | 130 | 93 | 76 | 44 | 25 |

TABLE 9

| Test | | | Blank | 5 | 6 | 7 | 8 |
|---|---|---|---|---|---|---|---|
| Concentration of Excel | | % | 6 | 6 | 6 | 6 | 6 |
| Size 22 starch Solution | | | | | | | |
| Ehcat 50 | DS | g/L | 0 | 1.5 | 2.0 | 3.0 | 4.0 |
| | 0.050-0.055 | | | | | | |

| | | | | | | |
|---|---|---|---|---|---|---|
| pH | | 7.51 | 5.95 | 5.69 | 5.41 | 5.23 |
| Viscosity | m · | 17 | 17 | 17 | 17 | 17 |
| | Pa · S | | | | | |
| Pick up | % | 5.31 | 5.36 | 5.40 | 5.20 | 5.14 |
| Cobb 60″ | g/m2 | 130 | 85 | 65 | 29 | 24 |

TABLE 10

| Test | | | Blank | 9 | 10 | 11 | 12 |
|---|---|---|---|---|---|---|---|
| Concentration of Excel | | % | 6 | 6 | 6 | 6 | 6 |
| Size 22 starch Solution | | | | | | | |
| Ehcat 69 | DS | g/L | 0 | 1.5 | 2.0 | 3.0 | 4.0 |
| | 0.060-0.070 | | | | | | |

| | | | | | | |
|---|---|---|---|---|---|---|
| pH | | 7.51 | 5.92 | 5.73 | 5.42 | 5.24 |
| Viscosity | m · | 17 | 17 | 17 | 17 | 17 |
| | Pa · S | | | | | |
| Pick up | % | 5.31 | 4.98 | 5.10 | 5.44 | 5.30 |
| Cobb 60″ | g/m2 | 130 | 80 | 62 | 28 | 22 |

TABLE 11

| Test | | | Blank | 13 | 14 | 15 | 16 |
|---|---|---|---|---|---|---|---|
| Concentration of Excel | | % | 6 | 6 | 6 | 6 | 6 |
| Size 22 starch Solution | | | | | | | |
| Ehcat 35 | DS | g/L | 0 | 1.5 | 2.0 | 3.0 | 4.0 |
| | 0.035-0.040 | | | | | | |

| | | | | | | |
|---|---|---|---|---|---|---|
| Alum | g/L | | 1.0 | 1.0 | 1.0 | 1.0 |
| pH | | 7.51 | 3.94 | 3.93 | 3.92 | 3.94 |
| Viscosity | m · | 17 | 17 | 17 | 17 | 17 |
| | Pa · S | | | | | |
| Pick up | % | 5.31 | 5.46 | 5.14 | 5.93 | 5.47 |
| Cobb 60″ | g/m2 | 130 | 51 | 27 | 23 | 20 |

TABLE 12

| Test | | | Blank | 17 | 18 | 19 | 20 |
|---|---|---|---|---|---|---|---|
| Concentration of Excel | | % | 6 | 6 | 6 | 6 | 6 |
| Size 22 starch Solution | | | | | | | |
| Ehcat 50 | DS | g/L | 0 | 1.5 | 2.0 | 3.0 | 4.0 |
| | 0.050-0.055 | | | | | | |

| | | | | | | |
|---|---|---|---|---|---|---|
| Alum | g/L | | 1.0 | 1.0 | 1.0 | 1.0 |
| pH | | 7.51 | 3.95 | 3.95 | 3.96 | 3.95 |
| Viscosity | m · | 17 | 17 | 17 | 17 | 17 |
| | Pa · S | | | | | |
| Pick up | % | 5.31 | 5.58 | 5.63 | 5.50 | 5.69 |
| Cobb 60″ | g/m2 | 130 | 42 | 22 | 21 | 19 |

TABLE 13

| Test | | | Blank | 21 | 22 | 23 | 24 |
|---|---|---|---|---|---|---|---|
| Concentration of Excel | | % | 6 | 6 | 6 | 6 | 6 |
| Size 22 starch Solution | | | | | | | |
| Ehcat 69 | DS | g/L | 0 | 1.5 | 2.0 | 3.0 | 4.0 |
| | 0.065-0.070 | | | | | | |

| | | | | | | |
|---|---|---|---|---|---|---|
| Alum | g/L | | 1.0 | 1.0 | 1.0 | 1.0 |
| pH | | 7.51 | 5.92 | 5.73 | 5.42 | 5.24 |
| Viscosity | m · | 17 | 17 | 17 | 17 | 17 |
| | Pa · S | | | | | |
| Pick up | % | 5.31 | 5.18 | 5.18 | 5.31 | 5.53 |
| Cobb 60″ | g/m2 | 130 | 40 | 25 | 22 | 19 |

For determining the degree of sizing of the surface-sized papers, the Cobb₆₀ value according to DIN EN 20 535 was determined. The water absorbing of the paper sheet in g/m² after contact with water and a contact time of 60 s is defined as the Cobb₆₀ value. The lower the Cobb₆₀ value, the better is the sizing effect of the dispersion used.

It can be seen from the results presented that the polymer dispersions containing the cationic tapioca starches of different degrees of substitution (DS) provide suitable sizing results. It can be seen that at low doses of cationic tapioca starch i.e. 1.5 or 2.0 g/L the starches with a higher degree of substitution provide relatively better Cobb 60 values than those with the lower degree of substitution. Nevertheless at doses of 3.0 and 4.0 g/L cationic tapioca starch the Cobb 60 values are all very good with less variation observed between the starches of different degrees of substitution.

Tables 11-13 show that when 1 g/L alum is incorporated into the polymer dispersion in conjunction with the respective cationic starch that improved sizing results are obtained. Although the best overall sizing results can be seen at the doses of 3.0 and 4.0 g/L cationic tapioca starch when the alum is included, the sizing results are significantly improved at the lower doses of 1.5 or 2.0 g/L cationic tapioca starch with 1 g/L alum by comparison to the equivalent dispersions in the absence of alum.

1: A finely divided, starch-containing aqueous polymer dispersion which is obtained by free radical emulsion polymerization of ethylenically unsaturated monomers in the presence of at least one redox initiator and starch,
wherein the ethylenically unsaturated monomers comprise:
(a) from 30 to 65% by weight of acrylonitrile and/or methacrylonitrile,
(b) from 35 to 60% by weight of at least one C₁-C₁₂-alkyl acrylate and/or at least one C₁-C₁₂-alkyl methacrylate,
(c) from 0 to 35% by weight of at least one other ethylenically unsaturated copolymerisable monomer,
wherein the sum of (a), (b) and (c) totals 100%,
and wherein the aqueous polymer dispersion comprises:
(d) from 10 to 55% by weight of an ionic tapioca starch,
wherein the weight of (d) is based on the total solids of components (a), (b), (c) and (d) of the aqueous polymer dispersion.

2: The finely divided, starch containing aqueous polymer dispersion according to claim 1, wherein the ionic tapioca starch is a degraded starch with a molar mass Mw of from 1,000 to 65,000 g/mol.

3: The finely divided, starch containing aqueous polymer dispersion according to claim 1, wherein
the ionic tapioca starch is anionic or cationic.

4: The finely divided, starch containing aqueous polymer dispersion according to claim 1, wherein
the free radical emulsion polymerization is carried out in the presence of at least 0.01% by weight, based on the weight of the ethylenically unsaturated monomers, of at least one terpene containing chain transfer agent.

5: The finely divided, starch-containing aqueous polymer dispersion according to claim 1, wherein the ethylenically unsaturated monomers comprise:
(a) from 40 to 60% by weight of acrylonitrile and/or methacrylonitrile,
(b) from 40 to 60% by weight of at least one C₁-C₁₂-alkyl acrylate and/or at least one C₁-C₁₂-alkyl methacrylate,
(c) from 0 to 20% by weight of at least one other ethylenically unsaturated copolymerisable monomer,
wherein the sum of (a), (b) and (c) totals 100%,
and wherein the aqueous polymer dispersion comprises:
(d) from 10 to 55% by weight of an anionic or cationic degraded tapioca starch with a molar mass Mw of from 1,000 to 65,000 g/mol, in which the weight of (d) is based on the total solids of components (a), (b), (c) and (d) of the aqueous polymer dispersion, and the free radical emulsion polymerization is carried out in the presence of at least 0.01% by weight, based on the weight of the ethylenically unsaturated monomers, of at least one terpene containing chain transfer agent.

6: The finely divided, starch-containing aqueous polymer dispersion according to claim 3, wherein the ethylenically unsaturated monomers comprise:
(a) from 40 to 60% by weight of acrylonitrile and/or methacrylonitrile,
(b) from 40 to 60% by weight of at least two of C₁-C₁₂-alkyl acrylate and/or C₁-C₁₂-alkyl methacrylate,
(c) from 0 to 20% by weight of at least one other ethylenically unsaturated copolymerisable monomer,
wherein the sum of (a), (b) and (c) totals 100%,
and wherein the aqueous polymer dispersion comprises:
(d) from 10 to 55% by weight of an anionic or cationic degraded tapioca starch with a molar mass Mw of from 1,000 to 65,000 g/mol, in which the weight of (d) is based on the total solids of components (a), (b), (c) and (d) of the aqueous polymer dispersion, and the free radical emulsion polymerization is carried out in the presence of at least 0.01% by weight, based on the weight of the ethylenically unsaturated monomers, of at least one terpene containing chain transfer agent.

7: The finely divided, starch-containing aqueous polymer dispersion according to claim 1, wherein the ethylenically unsaturated monomers comprise:
(a) from 40 to 60% by weight of acrylonitrile and/or methacrylonitrile,
(b) from 40 to 60% by weight of at least two of C₁-C₁₂-alkyl acrylate and/or C₁-C₁₂-alkyl methacrylate comprising (b1) at least one C₁-C₄-alkyl acrylate and/or at least one C₁-C₄-alkyl methacrylate, and (b2) at least one C₅-C₁₂-alkyl acrylate and/or at least one C₅-C₁₂-alkyl methacrylate,
(c) from 0 to 20% by weight of at least one other ethylenically unsaturated copolymerisable monomer,
wherein the sum of (a), (b) and (c) totals 100%,
and wherein the aqueous polymer dispersion comprises,
(d) from 10 to 55% by weight of an anionic or cationic degraded tapioca starch with a molar mass Mw of from 1,000 to 65,000 g/mol, in which the weight of (d) is based on the total solids of components (a), (b), (c) and (d) of the aqueous polymer dispersion, and the free radical emulsion polymerization is carried out in the presence of at least 0.01% by weight, based on the weight of the ethylenically unsaturated monomers, of at least one terpene containing chain transfer agent.

8: The finely divided, starch-containing aqueous polymer dispersion according to claim 7, wherein
component (b1) is at least one member selected from the group consisting of n-butyl acrylate and tertiary butyl acrylate and component (b2) is 2-ethylhexyl acrylate.

9: The finely divided, starch containing aqueous polymer dispersion according to claim 7, wherein
the ratio of component (b1) to component (b2) is 10:1 to 1:1.

10: The finely divided, starch-containing aqueous polymer dispersion according to claim 1, wherein the ethylenically unsaturated monomers comprise:
(a) from 40 to 60% by weight of acrylonitrile and/or methacrylonitrile,
(b) from 40 to 60% by weight of at least two of C₁-C₄-alkyl acrylate and/or C₁-C₄-alkyl methacrylate,
(c) from 0 to 20% by weight of at least one other ethylenically unsaturated copolymerisable monomer,
wherein the sum of (a), (b) and (c) totals 100%,
and wherein the aqueous polymer dispersion comprises:
(d) from 10 to 55% by weight of an anionic or cationic degraded tapioca starch with a molar mass Mw of from 1,000 to 65,000 g/mol, in which the weight of (d) is based on the total solids of components (a), (b), (c) and (d) of the aqueous polymer dispersion, and the free radical emulsion polymerization is carried out in the presence of at least 0.01% by weight, based on the weight of the ethylenically unsaturated monomers, of at least one terpene containing chain transfer agent.

11: The finely divided, starch-containing aqueous polymer dispersion according to claim 10, wherein
component (b) is a mixture that comprises at least one of n-butyl acrylate and tertiary butyl acrylate.

12: The finely divided, starch-containing aqueous polymer dispersion according to claim 1, wherein
the free radical emulsion polymerization is carried out in the presence of at least 0.01% by weight, based on the weight of the ethylenically unsaturated monomers, of at least one monocyclic monoterpene chain transfer agent.

13: The finely divided, starch-containing aqueous polymer dispersion according to claim 12, wherein
the monocyclic monoterpene is terpinolene.

14: The finely divided, starch-containing aqueous polymer dispersion according to claim 1, wherein
the free radical emulsion polymerization is carried out in the presence of 0.01 to 10% by weight, based on the weight of the ethylenically unsaturated monomers, of at least one terpene containing chain transfer agent.

15: The finely divided, starch-containing aqueous polymer dispersion according to claim 1, wherein
the free radical emulsion polymerization is carried out in the present of 0.01 to 5% by weight, based on the weight of the ethylenically unsaturated monomers, of at least one terpene containing chain transfer agent.

16: A process for the preparation of a finely divided, starch-containing aqueous polymer dispersion according to claim 1, the process comprising:
polymerizing, by free radical emulsion polymerization, the ethylenically unsaturated monomers in the presence of the at least one redox initiator and the starch.

17. (canceled)

18: A process of sizing paper, board, or cardboard, the method comprising, applying at least one finely divided, starch-containing aqueous polymer dispersion according to claim 1 to paper, board, or cardboard.
